(19) United States
(12) Patent Application Publication
(10) Pub. No.: US 2004/0149280 A1
(43) Pub. Date: Aug. 5, 2004

(54) METHOD AND APPARATUS FOR PREVENTING EAR ABRASION

(76) Inventor: Lisa Semeniuk, Calgary (CA)

Correspondence Address: BENNETT JONES, C/O MS ROSEANN CALDWELL, 4500 BANKERS HALL EAST, 855 - 2ND STREET, SW, CALGARY, AB, T2P 4K7, CA

(21) Appl. No.: 10/707,210

(22) Filed: Nov. 26, 2003

Related U.S. Application Data
(60) Provisional application No. 60/435,261, filed on Dec. 23, 2002.

(51) Int. Cl. A62B 18/00; A62B 17/04

(52) U.S. Cl. 128/201.22

(57) ABSTRACT

A method of preventing ear abrasion resulting from wearing oxygen masks and an oxygen mask and strap for use therefor, are disclosed. The method uses a strap that has a crown member and two side straps extending from the crown member. When the crown member engages the crown of a person's head, each side strap extends between the crown member and an attachment point on the oxygen mask along a path that is spaced in front of and above the ear. The strap is preferably made of a resilient material such as elastic. In one embodiment, the crown member has an upper and lower crown strap, which in another embodiment are connected by a transverse crown strap. In another aspect the invention is an oxygen mask and strap.

### BACKGROUND OF INVENTION

The present invention relates generally to oxygen masks and straps therefor, and in particular to a method and apparatus for preventing ear abrasion in persons who wear oxygen masks.

Oxygen mask straps commonly consist of a single thin elasticized strap that fits around a person's head, with the ends thereof securing each side of the oxygen mask. Straps of this type however, often secure the mask at an angle that results in ear abrasion and improper mask placement. Additionally, the strap easily slips out of position and frequent readjustment of the mask and strap are needed to establish proper, comfortable mask placement.

Ear abrasion is a common problem in persons who wear oxygen masks, especially if they wear them on a long-term basis. It results when the strap, often an elastic strap, rubs repeatedly against the same part of a person's ear. The part of the ear most commonly affected by ear abrasions is the top part, where the strap is generally caught and comes to rest, after it has slipped downwards out of its proper position. The abrasion on the top of the ear can be so severe as to actually result in the formation of a crevice or crack in which the strap rests and continues to cause damage.

Nursing staff often make futile efforts to comfort patients and prevent further damage to the ears, for example by readjusting the strap or by the application of Duoderm™ (an adhesive hydroactive dressing) to the affected area, which functions to promote epithelialisation of existing skin injuries and reduces contact of this area with the strap, acting prophylactically for the prevention of further friction damage. Patients who are unable to adjust the strap themselves are particularly prone to ear abrasion, as busy hospital staff, family or friends are not always able to readjust the strap if it is causing damage to the ears.

Given the frequency of ear abrasions in persons who wear oxygen masks, there is a need for a method and apparatus for use in preventing ear abrasion in persons who wear these masks.

### SUMMARY OF INVENTION

There is disclosed herein a method of preventing ear abrasion in a person who wears an oxygen mask. This method uses a strap to securely hold an oxygen mask over a person's mouth and/or nose, which strap will substantially remain in a selected position on the person's head and while in that position will not contact either ear of the person. Therefore, the person will not develop ear abrasions from the strap, as a result of wearing the oxygen mask.

A secondary benefit of this method is that the strap will remain in a selected position on a person's head, thereby substantially eliminating the need for frequent correction of the position of the strap.

There is additionally disclosed herein an oxygen mask and strap used to practice the method of this invention.

In one aspect therefore, this invention is a method of preventing ear abrasion resulting from wearing an oxygen mask, said method comprising the step of securing the oxygen mask over a respiratory outlet with a strap that:

(a) engages the crown of a head with a crown member that is spaced above both ears of the head, and

(b) attaches to the oxygen mask via two side straps that each extend along one side of the head between a junction on the crown member and an attachment point on the oxygen mask, along a path that is spaced in front of the ear on that one side of the head.

In another embodiment, this invention is a method of preventing ear abrasion in a person who wears an oxygen mask over a respiratory outlet, said method comprising:

(a) providing a strap that comprises:

(i) a crown member that engages the crown of the head of the person at a selected distance above both ears of the person, and

(ii) a pair of side straps, each side strap having a first end and a second end, said first end being attached to the crown member at a junction,

(b) connecting the second end of each side strap to one each of two attachment points on the oxygen mask, and

(c) using the strap to secure the oxygen mask over the respiratory outlet,

thereby causing each side strap to extend between the junction and the attachment point along a path that is spaced in front of each ear.

In another aspect, this invention is an oxygen mask and strap for use on a person, comprising:

(a) an oxygen mask having an attachment point on either side of the mask, and

(b) a strap having:

(i) a crown member engageable on the crown of the head of the person at a selected distance above both ears of the person, and

(ii) two side straps each having a first end and a second end, each first end being attached to opposed junctions on said crown member,

joined together by connecting each attachment point to the second end of one of the side straps, and characterized in that each side strap is spaced in front of an ear of the person when the mask and strap are in use.

In one embodiment, the crown member comprises an upper crown strap and a lower crown strap. In another embodiment a transverse crown strap connects the upper crown strap and the lower crown strap. In one embodiment the strap is comprised of a resilient material and in another embodiment the strap is made of an elastic material.

### BRIEF DESCRIPTION OF DRAWINGS

FIG. 1 is an elevation view of an embodiment of the strap of this invention being used to hold an oxygen mask over the respiratory outlet of a person.

FIG. 2A is a perspective view of an alternative embodiment of the strap used in this invention.

FIG. 2B is a top and back perspective view of the strap of FIG. 2A being used to hold an oxygen mask over the respiratory outlet of a person.

### DETAILED DESCRIPTION

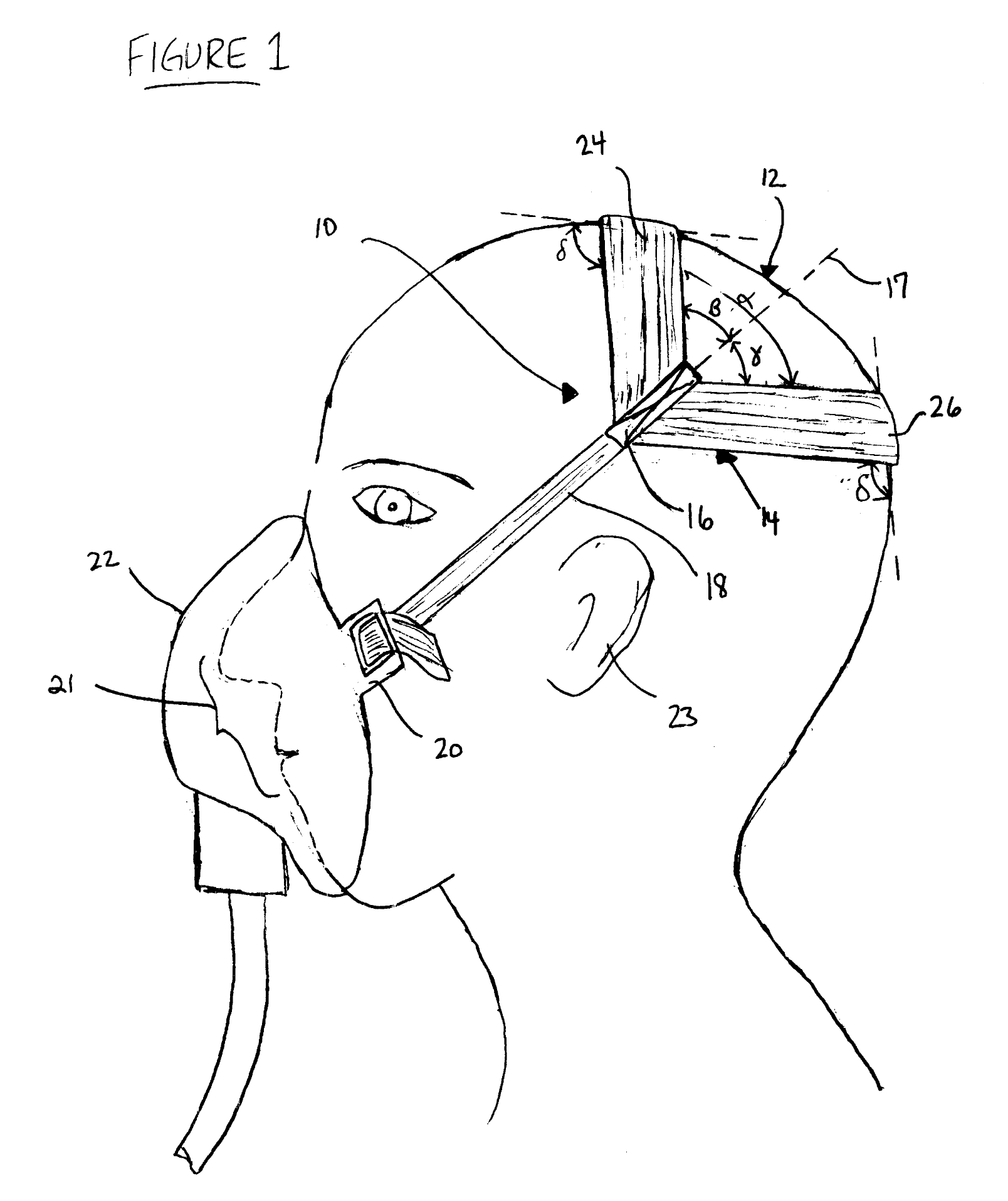

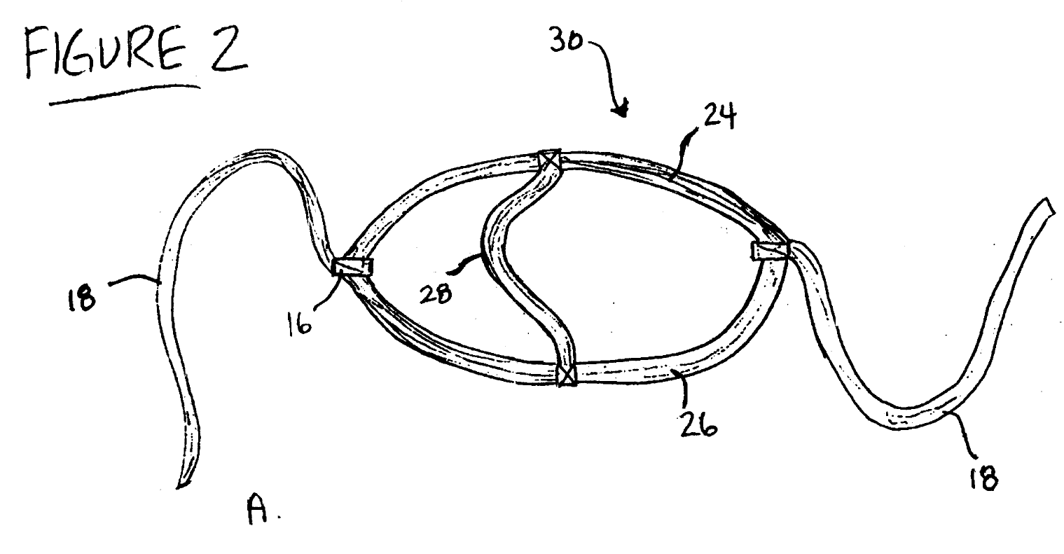

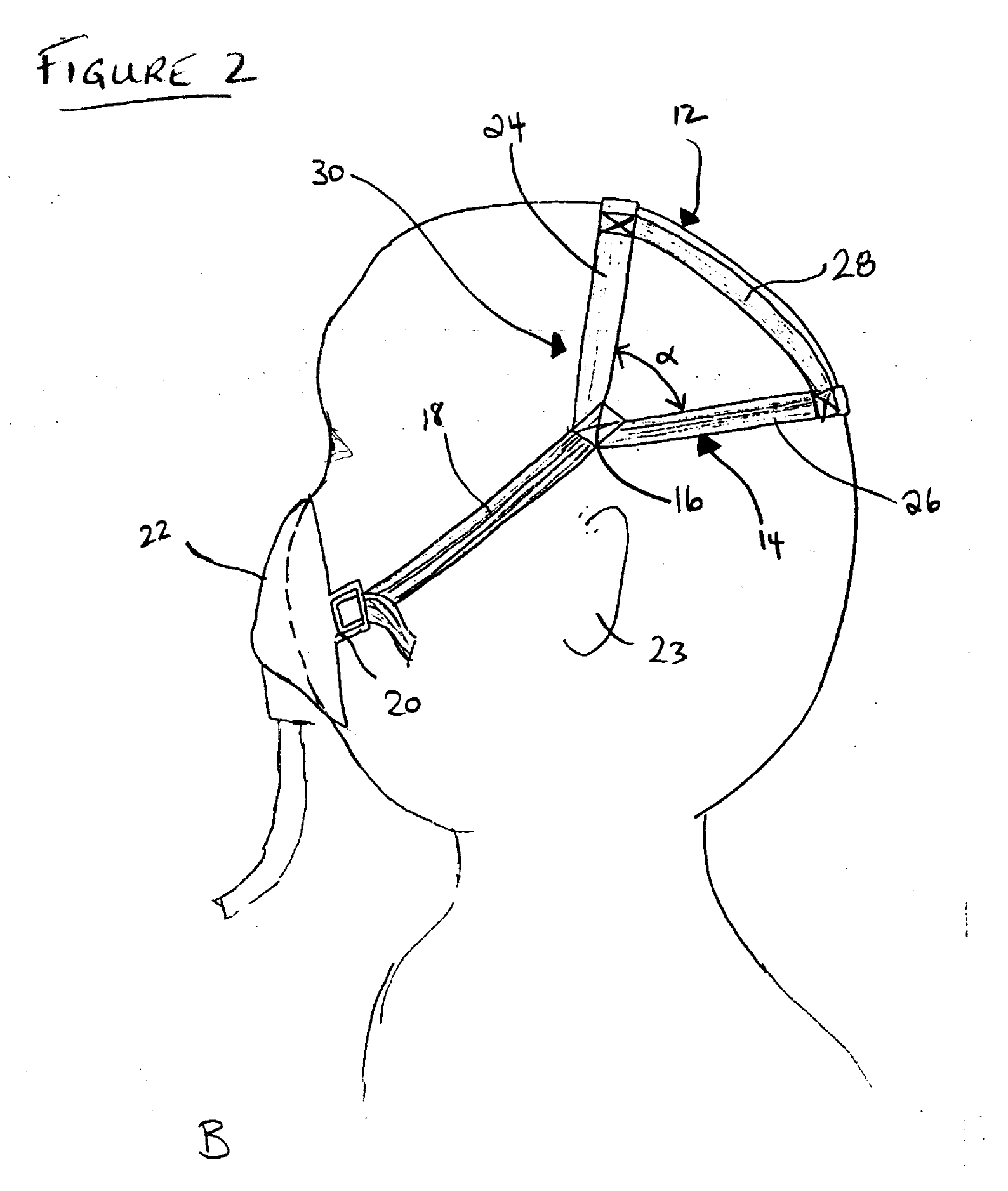

Reference will now be made to FIGS. 1 and 2, which show two embodiments of the strap 10 which may be used to prevent ear abrasion in persons who wear oxygen masks. As shown in FIG. 1, strap 10 includes a crown member 14 attached at junctions 16 to one end of a side strap 18. The other end of each side strap 18 is inserted into an attachment point 20 of oxygen mask 22. When oxygen mask 22 and strap 10 are positioned for use over a respiratory outlet 21 of a person, side strap 18 will extend between junction 16 and attachment point 20 along a path that is in front of, and does not touch, the person's ear 23. As used herein, “respiratory outlet” means the mouth and nose, or either the mouth or the nose.

The term “attached” as used herein when referring to side straps 18 and their relationship to crown member 14, or when referring to the crown member itself, is not limited to instances where the side straps and crown member are two separate units subsequently joined together, or when the crown member is made of two separate units subsequently joined together. Rather, the term is defined herein to include any strap 10 that has side straps 18 and a crown member 14, regardless of how the defined components of strap 10 are actually assembled. For example, a strap 10 that is manufactured as one unit is intended to be included herein.

Crown member 14 of strap 10 has a shape and size selected to engage a crown 12. “Crown” as used herein means the top and back region of a cranium. “Engage” as used herein refers to the ability of crown member 14 to remain at a selected position on crown 12, which ability results from both the binding forces exerted by crown member 14 on crown 12 and from the way that crown member 14 is constructed. More specifically, crown member 14 will bind to crown 12 via tension and frictional forces, as does a single elasticized strap currently used to hold oxygen masks over the respiratory outlet. However, crown member 14 is additionally able to resist it's own displacement off of crown 12. It is the ability of crown member 14 to engage crown 12 that ensures that strap 10 will not come into contact with ear 23 when oxygen mask 22 is being used.

Crown member 14 is able to resist displacement off of crown 12, as compared to a conventional oxygen mask strap that comprises a single elasticized strap that extends over the crown. When a conventional strap is positioned over the crown, the strap is held in that position by tension and frictional forces that operate on the crown along the length of the strap. However, if these forces are overcome, the strap is able to move up (forward) or down (backward) along the crown, thereby slipping out of its proper position. With crown member 14 of strap 10, if there is movement of the crown member or a part thereof, upwards (forwards) or downwards (backwards) on the crown, opposing forces generated by crown member 14 as a result of that movement will counteract the movement and thereby hold crown member 14 on the crown. As long as crown member 14 engages the crown, strap 10 will not contact the ears and cause ear abrasion.

One embodiment of crown member 14 is shown in FIG. 1. In this embodiment, the crown member is made of two crown straps 24 and 26, attached at junctions 16. Crown straps 24 and 26 bind to an upper part of crown 12 and a lower or back part of the crown, respectively. Therefore, when oxygen mask 22 is being held over respiratory outlet 21 by strap 10, crown strap 24 will resist the downward movement of crown strap 26, and likewise crown strap 26 will resist the upward or forward movement of crown strap 24. Together therefore, crown straps 24 and 26 cooperate to ensure that crown member 14 remains on crown 12.

Crown straps 24 and 26 are spaced from one another and sized relative to one another so that they are able to cooperate to ensure the engagement of crown 12 by crown member 14. The angle between crown straps 24 and 26 is represented by angle α in FIG. 1. As is apparent, if angle α is too small, crown straps 24 and 26 will be too close together to effectively ensure that crown member 14 will not be displaced from crown 12.

FIG. 2 shows another embodiment 30 of the strap of this invention, in which crown member 14 additionally has a transverse crown strap 28 that is attached at one end to crown strap 24 and at the other end to crown strap 26. Transverse crown strap 28 may be used for example, when crown straps 24 and 26 are made of a thinner and narrower elasticized strap than is used in crown straps shown in embodiment 10 of FIG. 1. Strap 28 therefore aids in ensuring that angle α is maintained between crown straps 24 and 26 by opposing the divergent shear (translational) force generated by these crown straps.

As is apparent, crown member 14 may be made of a number of crown straps and transverse elements that form a type of mesh or lattice that engages crown 12 of the head. Alternatively, crown member 14 may be made entirely of a single piece of material, such as a cloth material, that forms a type of cap or cover that engages crown 12 of the head. Embodiments of crown member 14 such as these are intended to be included herein and may be preferred in some circumstances, for example where greater comfort is desired, as these embodiments would minimize stress concentration by increasing the number of contact points of crown member 14 with crown 12.

Side straps 18 connect oxygen mask 22 to crown member 14 and draw the mask and crown member together to ensure that the mask is held securely over respiratory outlet 21. When strap 10 is used to hold oxygen mask 22 over respiratory outlet 21, as shown in FIGS. 1 and 2B, each side strap 18 extends between attachment point 20 on the oxygen mask 22 and junction 16 on crown member 14 along a path that is in front of, and does not touch, ear 23.

As shown in the Figures herein, the means of attaching strap 18 to mask 22 may be of a conventional type, namely a frictional engagement between side straps 18 and a loop structure at attachment points 20 on oxygen mask 22. However, other means of attachment, such as a snap, are intended to be included herein. A single attachment point 20 on either side of oxygen mask 22 enables the quick and simple attachment of the mask to the strap, and the quick and simple adjustment of the strap to the correct tension, when being used.

Crown member 14 has two junctions 16 on substantially opposite sides (one side not shown in FIG. 1 or 2B), each of which are a point of attachment of an end of one of the side straps 18. When oxygen mask 22 is held over respiratory outlet 21 by strap 10, as shown in FIG. 1 or 2B, neither ear 23 is in contact with any part of strap 10. Strap 10 is constructed so that, when in use, each junction 16 is located on the head of the person wearing the oxygen mask at a position that ensures that two circumstances occur. First, each junction 16 is at a position that ensures that each side strap 18 will extend between junction 16 and attachment point 20 along a path that is in front of, and does not touch, ear 23. Second, each junction 16 is at a position that ensures that crown strap 26, or the lower part of crown member 14, extends between both junctions 16 along a path that does not touch ears 23. As is apparent, in order to ensure that this second circumstance occurs, each junction 16 must be higher than the top part of each ear 23. As is also apparent, the location of junction 16 on the head of a person may have to be altered for different oxygen masks, as the position of the attachment points 20 on these masks may vary.

Having thus described the various components of strap 10, the preferred relationship of the components of the strap to the head of the wearer, and to one another, will now be detailed. However, it is understood that other relationships between the components of the strap and the head of the wearer, or between the components of the strap itself, can be used, and strap 10 will still be useful in the methods and apparatus of this invention.

Crown straps 24 and 26 preferably extend at a substantially orthogonal angle δ, as viewed from the side of the head, from the surface of crown 12 to junction 16. When crown straps 24 and 26 extend at this substantially orthogonal angle δ, junction 16 is positioned so that the dihedral angle bisector of angle α is substantially colinear with side straps 18, as shown by the dashed line 17 in FIG. 1. In this situation, angles β and Γ, shown in FIG. 1, are equal and the forces generated by crown straps 24 and 26 converge along a line midway between the straps.

Finally, junction 16 is located vertically higher than the top of ear 23. There is a useful vertical range along line 17 within which junction 16 can be positioned. The lower (vertically) on the head that junction 16 is placed, the smaller will be angle α. As is appreciated, when crown straps 24 and 26 are positioned too close together, their ability to engage crown 12 will be compromised. Likewise, the higher (vertically) on the head that junction 16 is placed, the greater will be angle α. Theoretically as angle α increases, the ability of crown member 14 to engage crown 12 will also increase, however, there is a point beyond which an increase in the magnitude of angle α will compromise the ability of crown straps 24 and 26 to engage crown 12. The inventors have found that angle α may vary greatly, but an angle α of between about 70 and 120 degrees is suitable for most embodiments of strap 10, with an angle α (of about 80 100 degrees being preferred, and an angle α of 90 degrees being particularly preferred.

In this preferred relationship of the various components of strap 10 to the head of the wearer and to each other, almost all force exerted by crown straps 24 and 26 will be tension force, and with the shear (translational) forces being minimized. Additionally, the tension force generated by side straps 18 will be directed along line 17, which is optimum for ensuring that oxygen mask 22 is held securely against the respiratory outlet 21 of the person wearing the mask.

The entire strap 10 may be made of a resilient material, such as a broad, flat band that is partially or completely made of elastic. Alternatively, only a portion of strap 10, for example only side straps 18, only crown member 14, or only a portion of side straps 18 or crown member 14, need be made of a resilient material. In these embodiments, the remainder of strap 10 may be made of a non-resilient material. The use of a resilient material somewhere in the strap is preferred because it provides for a more comfortable strap and for a strap that is more simply and quickly adjusted to the correct tension when in use. However, a strap made entirely of non-resilient material is intended to be included herein.

The cross-sectional dimensions of the various defined elements of strap 10 of this invention need not be the same, although they can be, as shown in FIG. 2. There fore, crown member 14 may be made of a resilient material, such as an elasticized strap, that is thicker and wider than the elasticized strap that makes up side straps 18, as shown in FIG. 1. What is important is that crown member 14 and side straps 18 are made of materials that substantially ensure that crown 12 is engaged while the oxygen mask is in use, and that no part of the strap 10 contacts the ear when the strap is adjusted to the correct tension, as described below.

In one embodiment comprising a transverse crown strap 28, the dimensions of the strap are as follows: (a) side straps are ⅜ inch wide and about 9 inches in length; (b) crown straps 24 and 26 are each about ½ inch wide and about 10 inches long; (c) angle α is about 90 degrees, and (d) transverse crown strap 28 is about ½ inch wide and 5½ inches long. All straps are made of polyester and spandex.

In the method of this invention, the free end of each side strap 18 is attached to one attachment point 20, to connect oxygen mask 22 and strap 10. Oxygen mask 22 and crown member 14 are then positioned over respiratory outlet 21 and crown 12 respectively of the head of the person who is to wear the mask, and side straps 18 are adjusted to the correct tension. The correct tension is established when crown member 14 and oxygen mask 22 are comfortably mounted over the respiratory outlet and crown, respectively, and yet securely held in place so that they will not slip therefrom to a position where strap 10 would come into contact with ears 23.

The type of oxygen mask that is used with strap 10 may vary, as strap 10 can be dimensioned differently for use with different types of masks. More particularly, the dimensions of strap 10 may vary according to the location of attachment point 20, when the mask is positioned over a respiratory outlet. Oxygen masks that have been found to be useful with strap 10 include 100% non-rebreather and cold neb oxygen masks.

While the invention has been described in conjunction with the disclosed embodiments, it will be understood that the invention is not intended to be limited to these embodiments. On the contrary, the invention is intended to cover alternatives, modifications and equivalents, which may be included within the spirit and scope of the invention as defined by the appended claims.

1. A method of preventing ear abrasion resulting from wearing an oxygen mask, said method comprising the step of securing the oxygen mask over a respiratory outlet using a strap that:
(a) engages the crown of a head with a crown member that is spaced above both ears of the head, and
(b) attaches to the oxygen mask via two side straps that each extend along one side of the head between a junction on the crown member and an attachment point on the oxygen mask, along a path that is spaced in front of the ear on that one side of the head.

2. The method of claim 1 wherein the crown member comprises an upper crown strap and a lower crown strap.

3. The method of claim 1 wherein the strap comprises a resilient material.

4. The method of claim 2 wherein the strap comprises a resilient material.

5. The method of claim 3 wherein the resilient material is an elastic material.

6. The method of claim 4 wherein the resilient material is an elastic material.

7. The method of claim 2 wherein the strap additionally comprises a transverse element that is connected at one end to the upper crown strap and connected at the other end to the lower crown strap.

8. The method of claim 7 wherein the transverse crown strap comprises a resilient material.

9. The method of claim 8 wherein the resilient material is an elastic material.

10. A method of preventing ear abrasion in a person who wears an oxygen mask over a respiratory outlet, said method comprising:
(a) providing a strap that comprises:
(i) a crown member that engages the crown of the head of the person at a selected distance above both ears of the person, and
(ii) a pair of side straps, each side strap having a first end and a second end, said first end being attached to the crown member at a junction,
(b) connecting the second end of each side strap to one each of two attachment points on the oxygen mask, and
(c) using the strap to secure the oxygen mask over the respiratory outlet,
thereby causing each side strap to extend between the junction and the attachment point along a path that is spaced in front of each ear.

11. The method of claim 10 wherein the crown member comprises an upper crown strap and a lower crown strap.

12. The method of claim 10 wherein the strap comprises a resilient material.

13. The method of claim 11 wherein the strap comprises a resilient material.

14. The method of claim 12 wherein the resilient material is an elastic material.

15. The method of claim 13 wherein the resilient material is an elastic material.

16. The method of claim 11 wherein the strap additionally comprises a transverse crown strap that is connected at one end to the upper crown strap and connected at the other end to the lower crown strap.

17. The method of claim 16 wherein the transverse crown strap comprises a resilient material.

18. The method of claim 17 wherein the transverse crown strap is an elastic material.

19. An oxygen mask and strap for use on a person, comprising:
(a) an oxygen mask having an attachment point on either side of the mask, and
(b) a strap having:
(i) a crown member engageable on the crown of the head of the person at a selected distance above both ears of the person, and
(ii) two side straps each having a first end and a second end, each first end being attached to said crown member at opposed junctions,
joined together by connecting each attachment point to the second end of one of the side straps, and characterized in that each side strap is spaced in front of an ear of the person when the mask and strap are in use.

20. The oxygen mask and strap of claim 19 wherein the crown member comprises an upper crown strap and a lower crown strap.

21. The oxygen mask and strap of claim 19 wherein the strap comprises a resilient material.

22. The oxygen mask and strap of claim 20 wherein the strap comprises a resilient material.

23. The oxygen mask and strap of claim 19 wherein strap is made of an elastic material.

24. The oxygen mask and strap of claim 20 wherein the strap made of an elastic material.

25. The oxygen mask and strap of claim 20 wherein the strap additionally comprises a transverse element that is connected at one end to the upper crown strap and connected at the other end to the lower crown strap.

26. The oxygen mask and strap of claim 25 wherein the transverse element comprises a resilient material.

27. The oxygen mask and strap of claim 25 wherein the transverse element is an elastic material.

28. An oxygen mask and strap for use on a person comprising:
(a) an oxygen mask having an attachment point on either side of the mask, and
(b) a strap with:
(i) a crown member comprising an upper crown strap, a lower crown strap and two opposed junctions;
(ii) a side strap extending from each said junction
(c) joined together by connecting each attachment point to the second end of one of the side straps, and characterized in that the crown member engages the crown above the ear, and each side strap is spaced in front of an ear of the person, when the mask and strap are in use.

29. The oxygen mask of claim 28 wherein a transverse crown strap extends between the upper crown strap and the lower crown strap.

30. The oxygen mask of claim 28 wherein the upper crown strap, the lower crown strap and the side straps comprise an elastic material.

31. The oxygen mask of claim 29 wherein the upper crown strap, the lower crown strap, the side straps and the transverse crown strap comprise an elastic material.
